(19) United States
(12) Patent Application Publication
(10) Pub. No.: US 2014/0118170 A1
(43) Pub. Date: May 1, 2014

(54) VEHICLE DETECTOR

(71) Applicant: EMX INDUSTRIES INC., Cleveland, OH (US)

(72) Inventors: Joseph Rozgonyi, Cleveland, OH (US); William Letterle, Cleveland, OH (US); Jeffrey E. Miller, Cleveland, OH (US)

(73) Assignee: EMX INDUSTRIES INC., Cleveland, OH (US)

(21) Appl. No.: 13/663,096

(22) Filed: Oct. 29, 2012

(51) Int. Cl. G08G 1/04

(52) U.S. Cl. 340/943

(57) ABSTRACT

A vehicle detector and method for detecting the presence of a vehicle. The vehicle detector includes an array of ultrasonic transducers to direct and receive ultrasonic beams to and from a target. Further, the vehicle detector includes a control system for turning on and off the ultrasonic transducers and for generating data corresponding to the distance between the vehicle detector and the target, the speed of the target, and the direction of motion of the target; and for comparing the generated data to stored data to determine whether or not a vehicle is present. Finally, the vehicle detector includes output circuitry that directs a signal to an external device whether or not a vehicle is present.

### TECHNICAL FIELD OF THE INVENTION

The present invention relates generally to a vehicle detector for detecting the presence of a vehicle. More specifically, the present invention relates to an array of ultrasonic transducers to direct and receive ultrasonic beams to and from a target, and a control system to signal to an external device whether or not a vehicle is present.

### BACKGROUND OF THE INVENTION

The need to detect vehicles is well established and used in many areas such as parking, traffic control, access control, car wash and drive-through applications. There are different technologies deployed in vehicle detectors such as infrared, microwave, magnetic field, and the most popular technology is the use of an inductive loop detector. The major disadvantage of the inductive loop detector is the cost of installing and maintaining inductive loop consisting of an electrical coil. This coil is installed in a roadway close to the surface and is subjected to harsh environment such as sun heat, ice, rain, deterioration due to chemicals in the roadway materials and mechanical deterioration of the roadway itself.

Additional disadvantage is the conflicting dependence of the inductive loop detector on the size of the inductive loop. The inductive loop has to be wide to achieve reliable detection of high bed vehicles and narrow to prevent detecting two closely following vehicles phenomenon known as tailgating. These conflicting requirements cause a compromise on the loop size and in turn a compromise in the loop detector performance.

### SUMMARY OF THE INVENTION

According to an embodiment of the present invention, a vehicle detector for detecting the presence of a vehicle. The vehicle detector includes an array of ultrasonic transducers to direct and receive ultrasonic beams to and from a target. Further, the vehicle detector includes a control system for turning on and off the ultrasonic transducers and for generating data corresponding to the distance between the vehicle detector and the target, the speed of the target, and the direction of motion of the target; and for comparing the generated data to stored data to determine whether or not a vehicle is present. Finally, the vehicle detector includes output circuitry that directs a signal to an external device whether or not a vehicle is present.

According to another embodiment of the present invention, a method of detecting the presence of a vehicle. The method includes directing and receiving ultrasonic beams to and from a target utilizing an array of ultrasonic transducers; turning on and off the ultrasonic transducers and generating data corresponding to the distance between the vehicle detector and the target, the speed of the target, and the direction of motion of the target using a control system; comparing the generated data to stored data to determine whether or not the target is a vehicle; and signaling an external device as to whether or not a vehicle is present.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices,” or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three dimensional view of the vehicle detector in use in the detection of a passing vehicle, in accordance with the present invention.

FIG. 2 is a cutaway side view of the vehicle detector with a schematic of ultrasonic transducers, in accordance with the present invention.

FIG. 3 is a cut away top view of the vehicle detector with a schematic of ultrasonic transducers, in accordance with the present invention.

FIG. 4 is a front view of the detection pattern of the ultrasonic transducers of the vehicle detector, in accordance with the present invention.

FIG. 5 is a side view of three detection patterns of the ultrasonic transducers of the vehicle detector on a vehicle within a period of time, in accordance with the present invention.

FIG. 6 is a schematic view of a control system that operates the vehicle detector, in accordance with the present invention.

FIG. 7 is a front three dimensional view of the detection pattern of the ultrasonic transducers of the vehicle detector when first encountered by a vehicle, in accordance with the present invention.

FIG. 8 is a side view of the detection pattern of the ultrasonic transducers of the vehicle detector as the vehicle continues to pass the vehicle detector, in accordance with the present invention.

FIG. 9 is a side view of a latter detection pattern of the ultrasonic transducers of the vehicle detector as the vehicle continues to pass the vehicle detector, in accordance with the present invention.

FIG. 10 is a side view of a latter detection pattern of the ultrasonic transducers of the vehicle detector as the vehicle continues to pass the vehicle detector, in accordance with the present invention.

FIG. 11 is a side view of a latter detection pattern of the ultrasonic transducers of the vehicle detector as the vehicle continues to pass the vehicle detector, in accordance with the present invention.

FIG. 12 is a side view of the detection pattern of the ultrasonic transducers of the vehicle detector as the vehicle continues to pass the vehicle detector, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

Vehicle detectors are widely used in traffic control, access control, safety control and drive-through applications. A variety of technologies are deployed for vehicle detection such as inductive field loop, magnetic field disturbance, microwave energy, infrared light, passive infrared sensing, pneumatic pressure differentiation, mechanical switches and ultrasound. Often one of the requirements in vehicle detection application is to sense the presence of a vehicle in the sensing area without false positives or negatives. For example, variation in vehicle surfaces such as wheel well or an open window can be interpreted by an ultrasonic device as vehicle not being present. On the other hand, objects such as a bird or a person passing by can be interpreted as a vehicle being present. An improved vehicle detector 10 utilizes ultrasonic technology as applied to vehicle detection. In general terms, the improved vehicle detector 10 detects the presence of stationary or slow moving vehicles, by transmitting an array of ultrasonic waves and analyzing the reflected waves for amplitude and frequency changes and shifts to determine if the vehicle is present in the line of sight of the improved vehicle detector. The improved vehicle detector 10 has the additional benefits of being easier to install than vehicle detectors in the prior art, and flexible mounting and aiming of the ultrasonic beams

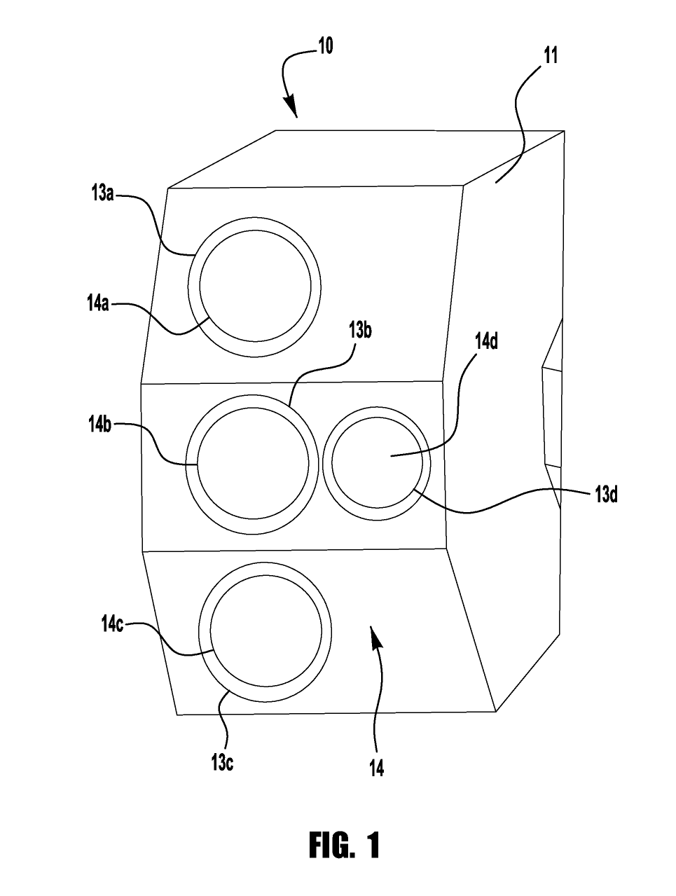

FIG. 1 illustrates the vehicle detector 10, which in use, is preferably designed to direct ultrasonic beams at a passing vehicle 12. Vehicle detector 10 has a housing 11 that is preferably constructed of a material that is weather resistant to withstand the elements. The housing 11 may be of any suitable dimensions.

Housing 11 includes an array 14 of four ultrasonic transducers 14a, 14b, 14c, and 14d (14a-14d). Ultrasonic transducers 14a-14d are contained and secured within the housing 11 behind openings 13a, 13b, 13c, 13d (13a-13d) so that the ultrasonic pulses generated by the transducers are emitted in as cone-shaped ultrasonic beams 17a, 17b, 17c, 17d and aimed at a target object 19 as discussed hereinafter. In use, cone-shaped ultrasonic beams are designed to optimally intersect a target object which comprises the various surfaces on a vehicle 12 as shown in FIG. 5.

While a small vehicle 12 is illustrated, it is within the terms of the invention for a wide variety of vehicles of different shapes and sizes to be detected with vehicle detector 10. Although four ultrasonic transducers are illustrated, it is within the terms of the embodiment that there be any number of desired ultrasonic transducers.

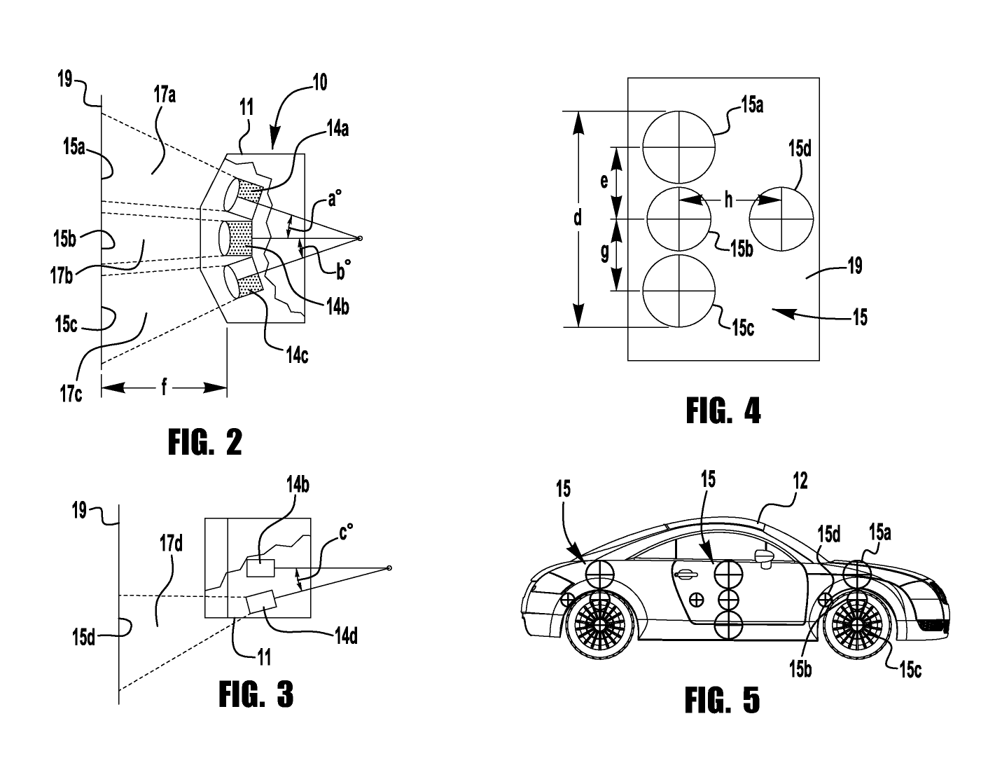

A more detailed view of the ultrasonic transducers 14a-14d is illustrated in FIGS. 2 and 3. The beams 17a, 17b, 17c, 17d are emitted from ultrasonic transducers 14a, 14b, 14c, and 14d. The angles a, b, and c between ultrasonic transducers 14a and 14b, 14b and 14c, and 14b and 14d, respectively, can have an angular differential of between about 9° and 13° and preferably about 11°. Ultrasonic transducers 14a-14d continuously pulse in waves to detect the presence of a vehicle. They are configured in such a way to eliminate false positives or false negatives.

The angles a, b, and c are selected to create a detection pattern 15 as shown in FIG. 4. The transducers 14a-14d generate a plurality of patterns 15a, 15b, 15c, 15d (15a-15d) on target 17 from the sound waves propagated by transducers 14a-14d, respectively, as seen in FIG. 4. Ultrasonic transducers 14a-14d are vertically disposed and aligned one above the other so as to generate the plurality of vertical detection patterns 15a, 15b, 15c. The vertical spread “d” from the top of the patterns 15a, 15b, 15c to the bottom of patterns is between about 2 and about 5 feet and preferably about 3 feet when the vehicle detector 10 is located about 5 feet from the target 19, typically a car as discussed herein after. The distance “e” between the centers of detection patterns 15a and 15b is between about 1 and about 2.5 feet, and preferably about 1 foot when the vehicle detector 10 is located a distance “f” of about 5 feet from the target 19. The distance “g” between the centers of detection patterns 15b and 15c is between about 1 and about 2.5 feet, and preferably about 1 foot when the vehicle detector 10 is located a distance “f” of about 5 feet from the target 19. The distance “h” between the centers of detection patterns 15b and 15d is between about 1 and about 2.5 feet, and preferably about 1 foot when the vehicle detector 10 is located a distance “f” of about 5 feet from the target 19.

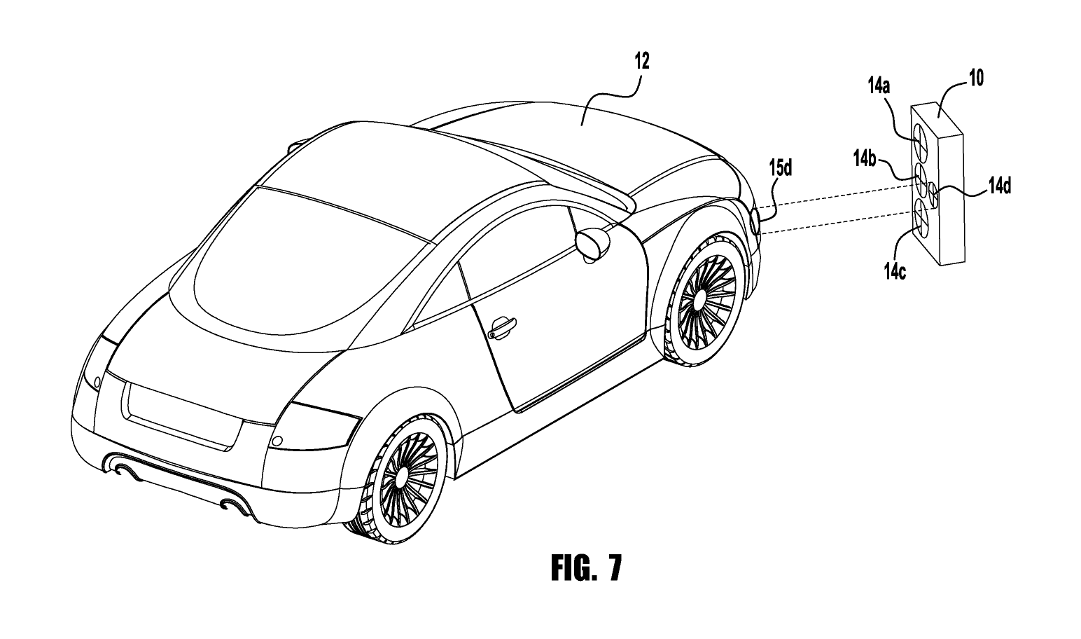

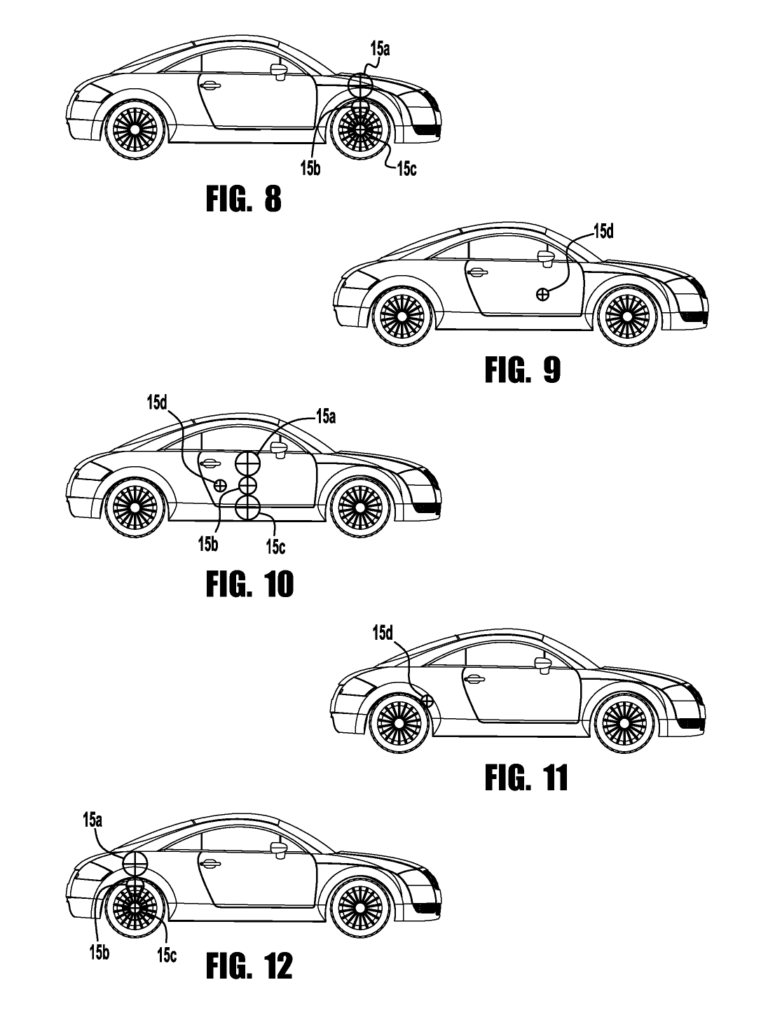

Offset ultrasonic transducer 14d is intentionally offset from the other ultrasonic transducers 14a-14c which are vertically disposed and aligned one above the other. Its function is to alert transducers 14a-14c about the possibility of the presence of a vehicle. When the vehicle detector 10 senses the presence of a vehicle 12, as seen in FIG. 5, based on the pulses of sound waves reflected by the target vehicle to the sensor, i.e., the offset ultrasonic transducer 14d, and detected as echoes. The vehicle detector 10 measures the time delay between each emitted and echo pulse to accurately determine the sensor-to-target distance based on the reading from ultrasonic transducer 14d. When a target has been identified by offset transducer 14d, as shown in FIGS. 7 and 8, the other ultrasonic transducers 14a-14c are utilized to verify the existence of a vehicle.

The location of the ultrasonic transducers 14a-14c with respect to each other ensure that the existence of a car can be accurately determined For example, if only one series of pulses of sound waves are directed at a vehicle with a high clearance, it is possible that a false negative would be read because the series of pulses could miss the car. However, the stacked detection pattern 15 of the ultrasonic transducers 14a-14c ensures a large area of the vehicle 12 is available for the pulses of sound waves from the ultrasonic transducers 14a-14c to be reflected back to the ultrasonic transducers 14a-14d for detection as echoes. This ensures an accurate determination of the existence of the car and the elimination of inaccurate readings. As long as at least two of the transducers in the stack of transducers 14a-14c receive reflected sound waves, the presence of a vehicle is registered by the vehicle detector 10. The transducers 14a-14d may be controlled to propagate sound waves every determined period of time, such as 1/100 of a second, or any other time the operator desires.

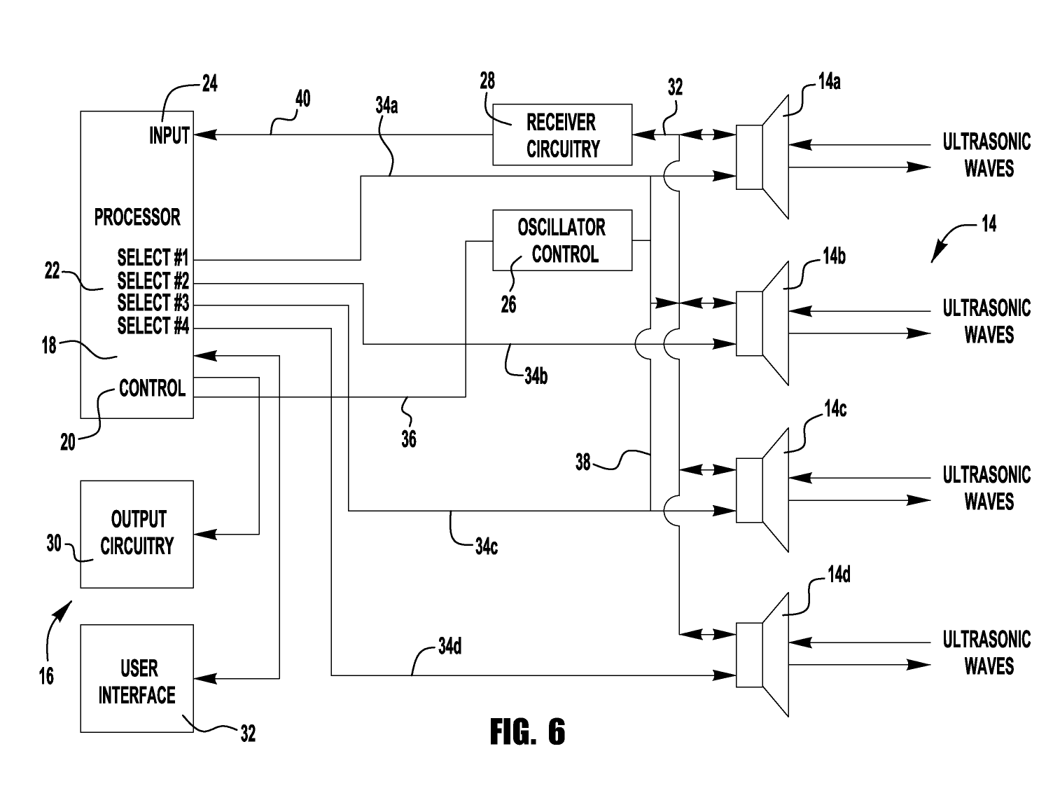

FIG. 6 illustrates a schematic view of the control system 16 that operates the vehicle detector 10. Control system 16 includes a microprocessor 18 that provides the control and analysis functions of the control system 16 and internally controls the vehicle detector 10. The microprocessor 18 consists of a control switch 20, switch selector 22 including switches 1, 2, 3 and 4 for turning on and off the ultrasonic transducers 14a-14d, and an input 24.

The amplitude, frequency shift, and delay between the burst transmission of the pulses of sound waves towards the target and their echo from the target, i.e., the vehicle, are analyzed by the microprocessor 18 to determine the distance to the target, the speed of the target, the direction of motion of the target and other characteristics of the target (such as size). The results of this analysis are compared to stored parameters and/or previous sample data to determine whether or not a vehicle is present. Combinations of data collected from various targets by the ultrasonic transducers 14a-14d can be stored in the microprocessor 18 as target profiles for future reference and as an aid in decision making by the control unit when deciding on presence or absence of a vehicle. The microprocessor 18 also employs algorithms that assess the status (i.e. target present or not present) of each ultrasonic transducer 14a-14d for multiple sample periods to increase the reliability of operation and prevent “drop out” when a vehicle is present. Furthermore, the microprocessor 18 can include devices such as humidity and/or temperature sensors and/or firmware to compensate for changes in humidity or temperature that affect the operation of the ultrasonic transducers 14a-14d or any other elements of the control system 16.

The microprocessor 18 operates by sequential sampling each of the ultrasonic transducers 14a-14d to determine if an object is present within the range of the vehicle detector 10. A timed frequency burst, controlled by select switches 1, 2, 3 and 4, is transmitted sequentially to ultrasonic transducers 14a-14d through lines 34a. 34b, 34c, 34d (34a-34d) respectively, Each of the ultrasonic transducers 14a-14d are turned on followed by a wait period until the reflected signal (echo) is received when the transducer is turned off. Then the next ultrasonic transducer is turned on and off and so on as they continuously cycle from one transducer to the next. The information about the reflected signal is directed into a line 32, through receiver circuitry 28 and into the input 24 of microprocessor 18 where the reflected signals are analyzed.

The oscillator control 26, which is connected to control 20 of the microprocessor 18 by line 36 regulates the voltage, current and frequency of the timed frequency burst to the ultrasonic transducers 14a-14d during the transmit cycle. In operation, the select switches 1, 2, 3 and 4 turn on one of the ultrasonic transducers 14a-14d. Then the oscillator control 26 directs a signal through line 38 to cause the then turned on transducer to pulse an ultrasonic beam towards the target 19. After an appropriate time, for example 25 milliseconds, the reflection from the target is received by the transducer and sent through line 32 to the receiver circuitry 28, which in turn relays this information through line 40 to the microprocessor 18. The receiver circuitry 28 amplifies the signal during the receive cycle, and relays the information through line 40 to the input 24 of the microprocessor 18.

This process is repeated for the remaining transducers 14a-14c. The entire cycle can be as fast as the operator desires, such as 0.01 second for each of the transducers 14a-14d to pulse an ultrasonic beam towards the target 19 and then receive the reflection.

As discussed earlier, the ultrasonic transducers 14a-14d provide a means of transmitting an ultrasonic burst and receiving the echo when the ultrasonic waves are reflected from an object within range. Use of multiple transducers in an array 14 provides a selective coverage area increasing vehicle detection capabilities and reducing the likelihood of detection dropout when certain areas such as wheel wells or when high body vehicles such as pick-up trucks are present. The selective coverage area prevents the detection of closely following vehicle as a continuation of the first vehicle. Furthermore, the ultrasonic transducers 14a-14d can measure the qualities of reflected ultrasonic energy from a target such as the amplitude and/or frequency and/or shift in frequency known as Doppler Effect, as well as transmit the ultrasonic energy towards the target. Further, the ultrasonic transducers 14a-14d can be mounted so that their location in housing 11 and/or to each other can be changed so that the direction of the ultrasonic energy being directed towards the target can be adjusted. In addition, optical elements such as a laser and/or an LED can be part of the ultrasonic array 14 to aid in positioning and adjusting the location of the ultrasonic energy on the target.

After the microprocessor 18 receives the information about the presence of a vehicle, it relays this to the output circuitry 30. Output Circuitry 30 consists of a relay and/or a solid-state output that provides the status of a vehicle, i.e. whether or not a vehicle is present, to an external device (not shown). The external device could include a gate, a traffic monitor, a drive through operator, or any other desired device.

A user interface 32 provides a means of setting sensitivity and other user selectable parameters. It also provides an output indicator showing the status of the vehicle detector 10, and whether the object vehicle is present or not.

It is within the terms of an embodiment that the vehicle detector 10 be protected by a protective hood, and/or heating and/or cooling system for optimal operation in outdoor environment.

According to an embodiment of the invention, a method of detecting the presence of a vehicle 12. This method includes directing and receiving ultrasonic beams 17a-17d to and from a target 19 utilizing an array of ultrasonic transducers 14a-14d; turning on and off the ultrasonic transducers and generating data corresponding to the distance between the vehicle detector 10 and the target, the speed of the target, and the direction of motion of the target using a control system; comparing the generated data to stored data to determine whether or not the target is a vehicle 12; and signaling an external device (not shown) as to whether or not a vehicle is present.

The method also includes pulsing ultrasonic beams 17a-17d of sound waves towards the target and receiving the echo of the sound waves from the target 19 to detect the presence of the target, by sequentially turning on and off timed frequency burst of the ultrasonic transducers 14a-14d during a transmit cycle. The voltage, current and frequency of the timed frequency burst to the ultrasonic transducers 14a-14d is regulated during the transmit cycle.

The method further includes receiving data generated by the reflection from the target 19 and in turn relaying this information to a microprocessor 18 for comparing the generated data to stored data to determine whether or not the target is a vehicle 12; and using output circuitry 30 to signal an external device as to whether or not a vehicle is present.

The method also includes emitting the ultrasonic beams 17a-17d from the ultrasonic transducers 14a-14d at an angle of between about 9° and 13°, and creating a detection pattern 15 on the target 19 with the ultrasonic beams.

The method further includes vertically disposing one of the ultrasonic transducers 14a above the other 14b to create at least two detection patterns 15a and 15b, one above the other on the target 19. Further, the method includes offsetting an offset ultrasonic transducer 14d from the at least two vertically disposed ultrasonic transducers 14a and 14b to create an offset detection pattern 15 adjacent the at least two detection patterns 15a and 15b on the target 19; and alerting the at least two vertically disposed ultrasonic transducers when a target is detected.

For example, as shown in FIG. 7, as a vehicle 12 passes a vehicle detector 10, a detection pattern 15d is reflected back to the transducer 14d. Once a target is recognized by detection pattern 15d, detection the array of ultrasonic transducers 14a, 14b, 14c are turned on to create detection patterns 15a, 15b, 15c as shown in FIG. 8. At that point detection pattern 15d may or may not still be reflecting back from the vehicle. Then as the vehicle 12 continues to pass the vehicle detector 10, as shown in FIG. 9, the ultrasonic transducers 14a, 14b, 14c are turned off and the detection pattern 15d is again reflected back to the transducer 14d. Once a target is again recognized by detection pattern 15d, detection the array of ultrasonic transducers 14a, 14b, 14c are turned on to create detection patterns 15a, 15b, 15c as shown in FIG. 10. At that point detection pattern 15d may or may not still be reflecting back from the vehicle.

Then as the vehicle 12 continues to pass the vehicle detector 10, as shown in FIG. 11, the ultrasonic transducers 14a, 14b, 14c are turned off and the detection pattern 15d is again reflected back to the transducer 14d. When the target, i.e. the vehicle, is again recognized by detection pattern 15d, detection the array of ultrasonic transducers 14a, 14b, 14c are turned on to create detection patterns 15a, 15b, 15c as shown in FIG. 12. At that point detection pattern 15d may or may not still be reflecting back from the vehicle.

Then as the vehicle 12 continues to pass the vehicle detector 10, as shown in FIG. 11, the ultrasonic transducers 14a, 14b, 14c are turned off and the detection pattern 15d is again reflected back to the transducer 14d. When the target, i.e. the vehicle, is again recognized by detection pattern 15d, detection the array of ultrasonic transducers 14a, 14b, 14c are turned on to create detection patterns 15a, 15b, 15c as shown in FIG. 12. At that point detection pattern 15d may or may not still be reflecting back from the vehicle.

Then as the vehicle 12 continues to pass the vehicle detector 10, not shown, the ultrasonic transducers 14a, 14b, 14c are turned off and the detection pattern 15d is not reflected back to the transducer 14d. Therefore, the target is not recognized by detection pattern 15d and the detection the array of ultrasonic transducers 14a, 14b, 14c are turned not on. The information that a car is not passing vehicle detector 10 can be relayed to the output circuitry 30 which can relay whether or not a vehicle is present to an external device.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A vehicle detector, comprising:
an array of ultrasonic transducers to direct and receive ultrasonic beams to and from a target;
a control system for turning on and off the ultrasonic transducers and for generating data corresponding to the distance between the vehicle detector and the target, the speed of the target, and the direction of motion of the target;
the control system for comparing the generated data to stored data to determine whether or not a vehicle is present; and
output circuitry that directs a signal to an external device whether or not a vehicle is present.

2. The vehicle detector of claim 2 wherein the ultrasonic transducers pulse sound waves towards the target and receive the echo of the sound waves from the target to detect the presence of the target.

3. The vehicle detector of claim 1 wherein the control system includes a microprocessor having a switch selector for sequentially turning on and off timed frequency burst of the ultrasonic transducers during a transmit cycle.

4. The vehicle detector of claim 3 wherein the microprocessor further includes an oscillator control to regulate the voltage, current and frequency of the timed frequency burst to the ultrasonic transducers during the transmit cycle.

5. The vehicle detector of claim 4 wherein the microprocessor further includes receiver circuitry which receives data generated by the reflection from the target and in turn relays this information to the microprocessor.

6. The vehicle detector of claim 1 wherein the array includes four ultrasonic transducers.

7. The vehicle detector of claim 2 wherein the ultrasonic beams emitted by the ultrasonic transducers are cone-shaped ultrasonic beams

8. The vehicle detector of claim 7 wherein the beams are emitted from ultrasonic transducers at an angle of between about 9° and 13°.

9. The vehicle detector of claim 8 wherein the beams create a detection pattern on the target.

10. The vehicle detector of claim 9 wherein at least two of the ultrasonic transducers are vertically disposed one above the other to create at least two detection patterns one above the other on the target.

11. The vehicle detector of claim 10 wherein an offset ultrasonic transducer is offset from the at least two vertically disposed ultrasonic transducers to create an offset detection pattern adjacent the at least two detection patterns on the target.

12. A method of detecting the presence of a vehicle, comprising:
directing and receiving ultrasonic beams to and from a target utilizing an array of ultrasonic transducers;
turning on and off the ultrasonic transducers and generating data corresponding to the distance between the vehicle detector and the target, the speed of the target, and the direction of motion of the target using a control system;
comparing the generated data to stored data to determine whether or not the target is a vehicle; and
signaling an external device as to whether or not a vehicle is present.

13. The method of detecting the presence of a vehicle of claim 12, including pulsing ultrasonic beams of sound waves towards the target and receiving the echo of the sound waves from the target to detect the presence of the target.

14. The method of detecting the presence of a vehicle of claim 13, including sequentially turning on and off timed frequency burst of the ultrasonic transducers during a transmit cycle.

15. The method of detecting the presence of a vehicle of claim 14, further including regulating the voltage, current and frequency of the timed frequency burst to the ultrasonic transducers during the transmit cycle.

16. The method of detecting the presence of a vehicle of claim 15, further including receiving data generated by the reflection from the target and in turn relaying this information to a microprocessor for comparing the generated data to stored data to determine whether or not the target is a vehicle;
and output circuitry for signaling an external device as to whether or not a vehicle is present.

17. The method of detecting the presence of a vehicle of claim 13, including emitting the ultrasonic beams from the ultrasonic transducers at an angle of between about 9° and 13°.

18. The method of detecting the presence of a vehicle of claim 13, further including creating a detection pattern on the target with the ultrasonic beams.

19. The method of detecting the presence of a vehicle of claim 13, including vertically disposing one of the ultrasonic transducers above the other to create at least two detection patterns one above the other on the target.

20. The method of detecting the presence of a vehicle of claim 13, further including:
offsetting an offset ultrasonic transducer from the at least two vertically disposed ultrasonic transducers to create an offset detection pattern adjacent the at least two detection patterns on the target; and
alerting the at least two vertically disposed ultrasonic transducers when a target is detected.
